(19) United States
(12) Patent Application Publication
(10) Pub. No.: US 2009/0011879 A1
(43) Pub. Date: Jan. 8, 2009

(54) BRACKET FOR CHAIN TENSIONER OR CHAIN GUIDE

(75) Inventor: Haruo Sakamoto, Nabari-shi (JP)

Correspondence Address: BORGWARNER INC.;c/o Brown & Michaels, PC, 400 M&T Bank Building, 118 N. Tioga Street, Ithaca, NY, 14850, US

(73) Assignee: BorgWarner Inc., Auburn Hills, MI (US)

(21) Appl. No.: 12/144,031

(22) Filed: Jun. 23, 2008

(30) Foreign Application Priority Data
Jul. 5, 2007 (JP) 2007-176875

(51) Int. Cl. F16H 7/08

(52) U.S. Cl. 474/111

(57) ABSTRACT

To reduce the bending stress acting on a bracket in a chain tensioner or chain guide when a chain is traveling, a bracket of a chain tensioner is provided with a laterally symmetrical transverse-sectional shape by bending one thin sheet of sheet metal having a thickness of preferably no more than 1 mm. The transverse-sectional shape is configured by a shoe mounting part and an upright wall part which projects to the back surface thereof, the structure of each of these comprising two layers of sheet metal, and the two sheets of sheet metal are fixedly attached by spot welding or the like, for example, at the upright wall part. The transverse-sectional shape includes substantially an “I” shape, “T” shape or triangular shape.

### BACKGROUND OF THE INVENTION

1. Field of the Invention

The invention pertains to the field of chain guides or chain tensioners. More particularly, the invention pertains to a bracket for a chain tensioner or chain guide.

2. Description of Related Art

Chains generally run between a drive sprocket on a drive side and a driven sprocket on a driven side. During operation of the chain, the tight-side span of the chain is on the side where the chain enters the drive sprocket and the slack-side span of the chain is on the side where the chain enters the driven sprocket.

A chain guide for guiding the travel of a chain is normally provided on the tight-side span of the chain, and a chain tensioner for applying tension to the chain is normally provided on the slack-side span.

Such a chain guide and chain tensioner comprise a shoe made of resin which has a sliding surface on which the chain slides during travel, and a bracket made of metal on which the shoe is mounted.

Conventional brackets have an “L”-shaped transverse section, as shown in FIG. 1 of U.S. Pat. No. 6,302,816, for example. Prior art FIG. 4 in the present application illustrates the mounted state of this kind of bracket having an “L”-shaped transverse section.

In prior art FIG. 4, one side 101 of an L-shaped bracket 100 is fixed to an engine block 102 by means of a bolt 103. A shoe (not depicted) on which a chain slides is provided on the other side 104 of the L-shaped bracket 100.

When the chain is moving, a downward pressing load w from the chain traveling on the shoe acts on the side 104, and a bending moment due to said pressing load w acts on the side 101. Bending stress caused by this bending moment is produced on the side 101, and strong bending stress is produced especially on the bolt mounting portion due to concentrated stress.

Consequently, it is necessary to use thick sheet metal (of the order of 3 mm, for example) for the bracket in order to prevent bending of and damage to the bracket due to bending stress in conventional chain guides and chain tensioners.

The present invention has been devised in view of this conventional situation, and the problem which the present invention is intended to resolve is that of reducing the bending stress acting on a bracket in a chain tensioner or chain guide when the chain is traveling.

### SUMMARY OF THE INVENTION

A bracket for chain tensioner or a chain guide, including a chain sliding surface mounted on the bracket. The bracket has a a laterally symmetrical transverse-sectional shape and is configured by bending a thin sheet of sheet metal.

The bracket is formed to have a laterally symmetrical transverse-sectional shape, and therefore the pressing load from the chain which acts on the bracket via the shoe when the chain is traveling on the chain sliding surface of the shoe is laterally symmetrical about an axis of symmetry of the bracket. By virtue of this, it is possible to balance on both lateral sides the bending moment acting on the bracket when the chain is traveling, as a result of which the bending stress acting on the bracket can be reduced.

The abovementioned transverse-sectional shape includes substantially an “I” shape, “T” shape or triangular shape.

The transverse-sectional shape of the bracket includes at least a shoe mounting part which extends in the longitudinal direction of the chain sliding surface of the shoe and which mounts the shoe, and an upright wall part which projects in a direction perpendicular to the shoe mounting part in the center in the width direction of the back surface of the shoe mounting part, and also extends in the longitudinal direction of the shoe mounting part, and the upright wall part comprises a mounting surface for the bracket.

In this case, the transverse section of the bracket is formed to be substantially “I”-shaped (including “I”-shaped) or “T”-shaped, and it is possible to balance on both lateral sides of the upright wall part the bending moment acting on the upright wall part when the chain is traveling, as a result of which the bending stress acting on the upright wall part of the bracket can be reduced.

The bracket is configured by bending one sheet of sheet metal, and also the upright wall part has a structure comprising two layers of sheet metal, and two sheets of the sheet metal are fixedly attached at the upright wall part.

The fixed attachment method is any of welding, brazing or bonding.

The thickness of the bracket is preferably no more than 1 mm.

The bracket for a chain tensioner or a chain guide, on which bracket a shoe comprising a chain sliding surface is mounted, said bracket being configured by bending a thin sheet of sheet metal, and also comprising at least a shoe mounting part for mounting the abovementioned shoe, and an upright wall part which projects in a direction perpendicular to the abovementioned shoe mounting part in the center in the width direction of the back surface of the abovementioned shoe mounting part, and the abovementioned upright wall part comprises a mounting surface for said bracket.

The pressing load from the chain acting on the bracket via the shoe when the chain is traveling on the chain sliding surface of the shoe is laterally symmetrical. By virtue of this, it is possible to balance on both lateral sides of the upright wall part the bending moment acting on the bracket when the chain is traveling, as a result of which the bending stress acting on the upright wall part of the bracket can be reduced.

A thin sheet of sheet metal is bent to give the bracket a transverse-sectional shape which is laterally symmetrical and therefore the pressing load from the chain which acts on the bracket via the shoe when the chain is traveling on the chain sliding surface of the shoe is laterally symmetrical about an axis of symmetry of the bracket. By virtue of this, it is possible to balance on both lateral sides the bending moment acting on the bracket when the chain is traveling, as a result of which the bending stress acting on the bracket can be reduced.

### BRIEF DESCRIPTION OF THE DRAWING

FIG. 1 is a schematic side view of a chain tensioner including a chain tensioner bracket according to one exemplary embodiment of the present invention.

FIG. 1A is a view in cross section along the line IA-IA of FIG. 1.

FIG. 1B is a view in cross section along the line IB-IB of FIG. 1.

FIG. 2 is a schematic side view of a chain guide including a chain guide bracket according to one exemplary embodiment of the present invention.

FIG. 2A is a view in cross section along the line IIA-IIA of FIG. 2.

FIG. 3 is a view in transverse section of a bracket according to another exemplary embodiment of the present invention.

FIG. 4 is a view in transverse section of a conventional bracket.

### DETAILED DESCRIPTION OF THE INVENTION

An exemplary embodiment of the present invention will be described below on the basis of the appended drawings.

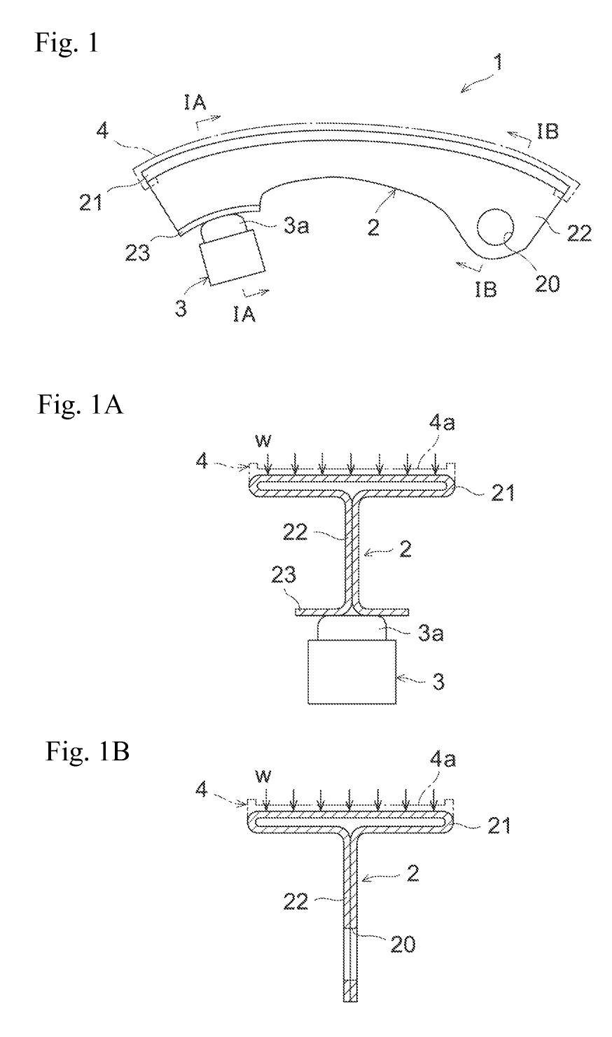

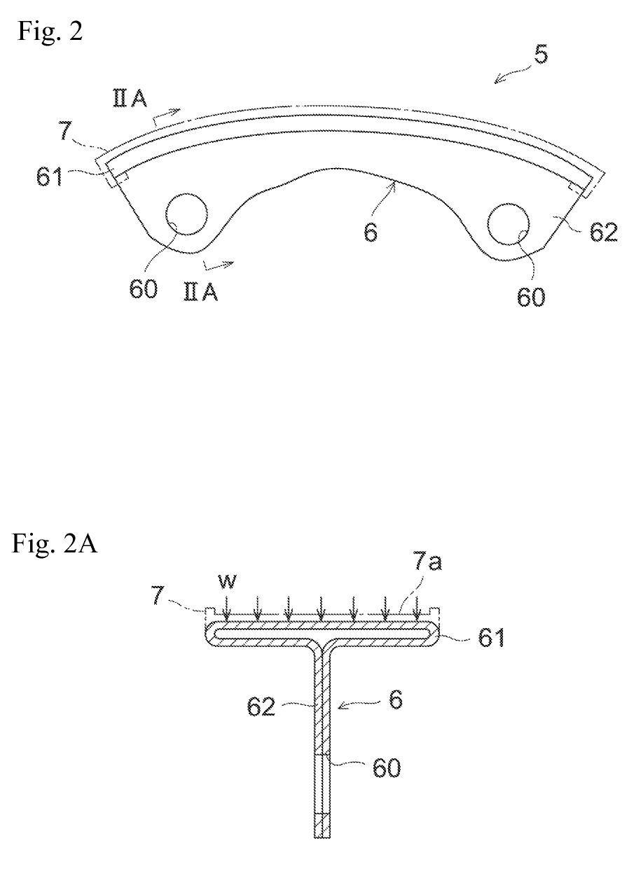

FIG. 1 to FIG. 1B illustrate a bracket for a chain tensioner according to one exemplary embodiment of the present invention, where FIG. 1 is a schematic side view of a chain tensioner including a bracket according to this exemplary embodiment, FIG. 2 is a view in cross section along the line IA-IA in FIG. 1, and FIG. 1B is a view in cross section along the line IB-IB in FIG. 1. It should be noted that in the figures the shoe is denoted by a single-dot chain line for ease of illustration.

As shown in FIG. 1, a chain tensioner 1 acts to exert tension on a chain which is not depicted, and comprises a bracket 2 which is made of metal, one end of which is pivotably supported, a hydraulic tensioner 3 for exerting a pressing force on the other end of the bracket 2, and a shoe 4 which is made of resin and attached to the bracket 2.

The bracket 2 comprises a pivot hole 20 which is made through one end thereof, and the bracket is mounted on an engine block by way of a shaft support member (not depicted) such as a bolt which is inserted into the pivot hole 20. The bracket 2 has freedom to pivot about the shaft centre of the shaft support member. A shoe 4 is mounted on the shoe mounting part 21 comprises a chain sliding surface on the top of the bracket on which the chain slides during travel. Furthermore, a tensioner abutment part 23 which a piston rod 3a of the hydraulic tensioner 3 can abut is provided at the other end of the bracket 2.

As shown in FIGS. 1A and 1B, the bracket 2 is preferably configured by bending a thin sheet of sheet metal having a thickness of no more than 1 mm, to a transverse-sectional shape that is laterally symmetrical. SPCC (steel plate cold commercial) or SAPH (steel automobile press hot) or the like is used as the material for the sheet metal, for example.

The bracket 2 has a substantially “T”-shaped transverse section, as shown in FIG. 1B, in the region where it is not for the most part abutted by the hydraulic tensioner 3. That is, the transverse-sectional shape of the bracket 2 comprises a shoe mounting part 21 extending in the longitudinal direction of a chain sliding surface 4a of the shoe 4, and an upright wall part 22 which projects in a direction perpendicular to the shoe mounting part 21 and in the center in the width direction of the back surface of the shoe mounting part 21, and also which extends in the longitudinal direction of the shoe mounting part 21. As shown in FIG. 1B, one surface of the upright wall part 22 forms a mounting surface with the engine block.

The bracket 2 is preferably configured by bending one sheet of sheet metal, and, as shown in FIG. 1B, both the shoe mounting part 21 and the upright wall part 22 have a structure comprising two layers of sheet metal. Two sheets of sheet metal are fixedly attached to each other by welding, such as spot welding, brazing, bonding or the like, at the upright wall part 22 of the bracket 2.

The bracket 2 has a substantially “I”-shaped (including “I”-shaped) transverse section in the region of abutment of the hydraulic tensioner 3, as shown in FIG. 1A. That is, the transverse-sectional shape of the bracket 2 comprises a shoe mounting part 21 extending in the longitudinal direction of the chain sliding surface 4a of the shoe 4, an upright wall part 22 which projects in a direction perpendicular to the shoe mounting part 21 in the center in the width direction of the back surface of the shoe mounting part 21, and also which extends in the longitudinal direction of the shoe mounting part 21, and a tensioner abutment part 23 which extends from the lower end of the upright wall part 22 substantially in the longitudinal direction of the shoe mounting part 21 while running perpendicular to the upright wall part 22. The tensioner abutment part 23 projects in a lateral direction substantially perpendicular to the upright wall part 22 at the lower end of the upright wall part 22.

FIG. 2 and FIG. 2A illustrate the chain guide bracket according to one exemplary embodiment of the present invention, FIG. 2 being a schematic side view of a chain guide including the bracket according to this exemplary embodiment, and FIG. 2A being a view in cross section along the line IIA-IIA of FIG. 2.

As shown in FIG. 2, a chain guide 5 is intended to guide the travel of the chain which is not depicted, and the chain guide 5 comprises a bracket 6 made of metal of which both ends are fixed, and a shoe 7 which is made of resin and is attached to the bracket 6.

The bracket 6 comprises mounting holes 60 which are made through both ends, and the bracket 6 is fixed to the engine block by way of shaft support members (not depicted) such as bolts which are inserted into the mounting holes 60. A shoe 7 is mounted on the shoe mounting part 61 and comprises a chain sliding surface on the upper part of the bracket 6 which the chain slides during travel.

As shown in FIG. 2A, the bracket 6 is preferably configured by bending a thin sheet of sheet metal having a thickness of no more than 1 mm, and the transverse-sectional shape is laterally symmetrical. SPCC (steel plate cold commercial) or SAPH (steel automobile press hot) or the like is used as the material for the sheet metal, for example, in the same way as for the bracket 2.

The bracket 6 has a substantially “T”-shaped transverse section, as shown in FIG. 2A. That is, the transverse-sectional shape of the bracket 6 comprises a shoe mounting part 61 extending in the longitudinal direction of a chain sliding surface 7a of the shoe 7, and an upright wall part 62 which projects in a direction perpendicular to the shoe mounting part 61 in the center in the width direction of the back surface of the shoe mounting part 61, and also extends in the longitudinal direction of the shoe mounting part 61. As shown in FIG. 2A, one surface of the upright wall part 62 forms a mounting surface with the engine block.

The bracket 6 is preferably configured by bending one sheet of sheet metal, and, as shown in FIG. 2A, both the shoe mounting part 61 and the upright wall part 62 have a structure comprising two layers of sheet metal. Two sheets of sheet metal are fixedly attached to each other by welding, such as spot welding, brazing, bonding or the like, at the upright wall part 62 of the bracket 6.

According to this exemplary embodiment, the transverse-sectional shape of the brackets 2, 6 is formed to be laterally symmetrical, and therefore the pressing load w from the chain acting on the brackets 2, 6 by way of the shoes 4, 7 when the chain is traveling on the chain sliding surfaces 4a, 7a of the shoes 4, 7 is laterally symmetrical about an axis of symmetry of the brackets 2, 6 (see FIGS. 1A, 1B and 2A). By virtue of this, it is possible to balance on both lateral sides, the bending moment acting on the brackets 2, 6 when the chain is traveling, as a result of which the bending stress acting on the brackets 2, 6 can be reduced.

Furthermore, in this instance, the transverse section of the brackets 2, 6 is formed to be substantially “T”-shaped or “I”-shaped (including “I”-shaped) by means of the shoe mounting parts 21, 61, the upright wall parts 22, 62 and the tensioner abutment part 23, and one side surface of the upright wall parts 22, 62 forms a mounting surface with the engine block. Therefore it is possible to balance on both lateral sides of the upright wall parts 22, 62 the bending moment acting on the upright wall parts 22, 62 when the chain is traveling, as a result of which the bending stress acting on the upright wall parts 22, 62 of the brackets 2, 6 can be reduced.

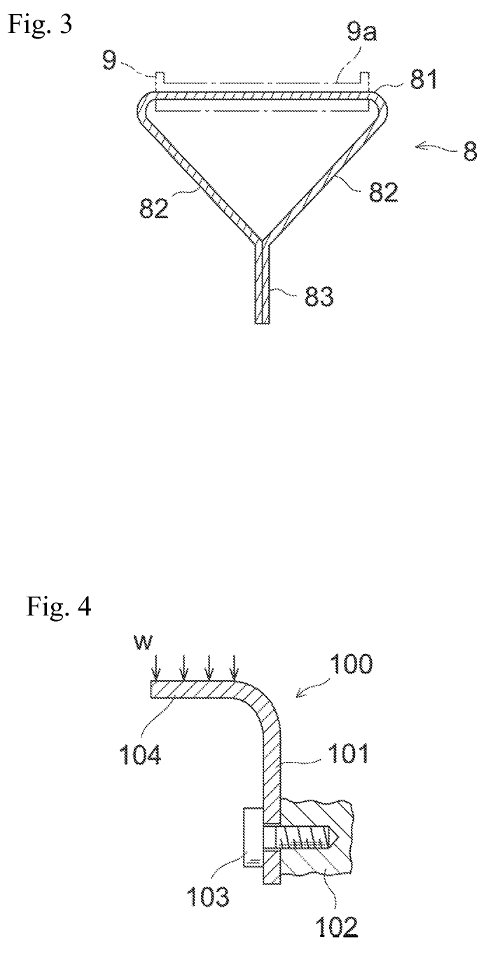

A description has been given in the exemplary embodiment described above of an example in which the transverse section of the bracket is substantially “T”-shaped or “I”-shaped, but the present invention can also be applied in the same way to brackets having a different transverse-sectional shape. FIG. 3 shows a case including an inverted triangular shape as another transverse-sectional shape of the bracket. FIG. 3 also shows the transverse-sectional shape of a chain tensioner bracket and a chain guide bracket roughly in the center in the longitudinal direction.

This bracket 8, the transverse-sectional shape of the bracket 2 comprises a shoe mounting part 81 extending in the longitudinal direction of a chain sliding surface 9a of a shoe 9, left and right oblique wall parts 82 which are disposed so as to form an inverted isosceles triangle of which one side is the shoe mounting part 81, and an upright wall part 83 which projects from the lower end of the oblique wall parts 82 in a direction perpendicular to the shoe mounting part 81, and also extends in the longitudinal direction of the shoe mounting part 81.

The bracket 8 is configured by bending one sheet of sheet metal, while the structure of the shoe mounting part 81 and the oblique wall parts 82 comprises one layer of sheet metal, and the structure of the upright wall part 83 comprises two layers of sheet metal. Two sheets of sheet metal are fixedly attached to each other by welding, such as spot welding, brazing, bonding or the like, at the upright wall part 83 of the bracket 8.

It should be noted that when the bracket 8 is applied to a chain tensioner, the lower ends of the upright wall part 83 are extended further downward in the region of abutment of the hydraulic tensioner, and along with this, the respective lower ends are bent laterally at right angles to provide a tensioner abutment part (not depicted). Furthermore, when the bracket 8 is applied to a chain guide, both lower ends of the upright wall part 83 are extended downward to form a mounting hole (not depicted).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A bracket for a chain tensioner or a chain guide and a shoe including a chain sliding surface mounted on the bracket, wherein the bracket is configured by bending a thin sheet of sheet metal and has a laterally symmetrical transverse-sectional shape.

2. The bracket as claimed in claim 1, wherein the transverse-sectional shape is substantially an “I” shape, “T” shape or triangular shape.

3. The bracket as claimed in claim 1, wherein the transverse-sectional shape comprises at least a shoe mounting part which extends in the longitudinal direction of the the chain sliding surface of the shoe and which mounts the shoe and an upright wall part which projects in a direction perpendicular to the shoe mounting part in the center in the width direction of the back surface of the shoe mounting part, and also extends in the longitudinal direction of the shoe mounting part, and the upright wall part comprises a mounting surface for said bracket.

4. The bracket as claimed in claim 3, wherein said bracket is configured by bending one sheet of sheet metal, and also the upright wall part has a structure comprising two layers of the sheet metal, and two sheets of the sheet metal are fixedly attached at the upright wall part.

5. The bracket as claimed in claim 4, wherein the fixed attachment method is welding, brazing, or bonding.

6. The bracket as claimed in claim 1, wherein the thickness of said bracket is no more than 1 mm.

7. A bracket for a chain tensioner or a chain guide and a shoe including a chain sliding surface mounted on the bracket, wherein the bracket is configured by bending a thin sheet of sheet metal, and also the bracket comprises at least a shoe mounting part for mounting the shoe, and an upright wall part which projects in a direction perpendicular to the shoe mounting part in the center in the width direction of the back surface of the shoe mounting part, and the upright wall part comprises a mounting surface for said bracket.
